(19) United States
(12) Patent Application Publication
(10) Pub. No.: US 2015/0204112 A1
(43) Pub. Date: Jul. 23, 2015

(54) LOCKING DEVICE FOR A BICYCLE

(71) Applicant: Velolock Ltd., London (GB)

(72) Inventors: Franz Salzmann, Wien (AT); Daniel Zajarias-Fainsod, Oxford (GB); Benjamin Peach, West Sussex (GB)

(21) Appl. No.: 14/415,758

(22) PCT Filed: Jul. 22, 2013
(86) PCT No.: PCT/EP2013/002165

§ 371 Date: Jan. 20, 2015

(30) Foreign Application Priority Data
Jul. 20, 2012 (EP) PCT/EP2012/003082

(51) Int. Cl. E05B 71/00; E05B 45/00; G01S 19/16

(52) U.S. Cl. CPC E05B 71/00; G01S 19/16; E05B 45/005

(57) ABSTRACT

The invention is related to a locking device (30; 50) for a bicycle, comprising a main housing (1) which is attachable to a component of the bicycle, a cable (22), wherein both cable ends (17, 18) are lockable inside the main housing (1), a GPS module (12) for locating the locking device arranged inside the main housing (1), a radio frequency device (11) at least for transmitting at least a signal encoding at least a parameter of the locking device to a remote receiving means, comprising at least a radio frequency chip and an antenna. The main housing (1) comprises two parts: either a component case (51) and a clamp (52), wherein the clamp (52) comprises a first and a second clamp element (62, 63) forming in an attached state a space (2) for embracing the component (54) of the bicycle, wherein the component case (51) is detachably attachable to the first clamp element (62) by main attachment means (10, 60, 61) or a back case (1a) and a front case (1b), which are detachably attachable to one another by first and second attachment means (3, 5; 4, 6, 7), the back case (1a) and the front case (1b) being formed in such a way that in an attached state they form a space (2) for embracing the component of the bicycle and in that the first and the second attachment means comprise each interacting elements (3, 5; 4, 6, 7) arranged in the back case (1a) and in the front case (1b).

### TECHNICAL FIELD

The invention is related to a locking device for a bicycle and a method for securing the locking device to a bicycle component according to the respective independent claims.

### BACKGROUND ART

A large variety of locking devices for bicycles are available on the market.

U.S. Pat. No. 7,104,091 discloses a bicycle lock which can be fastened to the seat support of a bicycle. The fastening to the seat support is done in such a way that the seat support is guided through a hole in the body of the lock and fastened by a fastening element of the lock. This solution has the disadvantage that the seat support has to be removed from the bicycle in order to fasten the lock and that the lock may be removed from the bicycle by simply removing the entire seat and its support.

U.S. Pat. No. 7,543,467 discloses a portable locking device with a wireless transmitter that transmits the condition of the locking device to a receiver of a security system. The disadvantage of this solution is that the housing of the locking solution cannot be attached to a bicycle component. Thus, when unlocking the bicycle, the entire locking device has to be removed and stored, which reduces the comfort.

### DISCLOSURE OF THE INVENTION

Hence, it is a general object of the invention to provide an improved locking device which does not have said disadvantages.

Now, in order to implement this and still further objects of the invention, which will become more readily apparent as the description proceeds, the locking device according to the invention comprises

a main housing which is attachable to a component of the bicycle;

a cable, wherein both cable ends are lockable inside the main housing;

a GPS module for locating the locking device arranged inside the main housing;

a radio frequency device at least for transmitting at least a signal encoding at least a parameter of the locking device to a remote receiving means, comprising at least a radio frequency chip and an antenna. The main housing comprises two parts: either a component case and a clamp, wherein the clamp comprises a first and a second clamp element forming in an attached state a space for embracing the component of the bicycle, wherein the component case is detachably attachable to the first clamp element by main attachment means, or a back case and a front case, which are detachably attachable to one another by first and second attachment means, wherein the back case and the front case are formed in such a way that in an attached state they form a space for embracing the component of the bicycle and the first and the second attachment means comprise each interacting elements arranged in the back case and in the front case for securing the two cases to one another.

The method for securing the locking device according to the invention to a bicycle comprises the step of embracing a component of the bicycle, by the back and front the case or by the first and the second clamp elements.

In the following the invention is described by means of two embodiments of the locking device. It is noted that the terms “component of the bicycle” and “frame component” are used to differentiate between two distinct components. However they may be of the same type, e.g. tubes, stays, forks, etc. of the bicycle frame.

### BRIEF DESCRIPTION OF THE DRAWINGS

The invention will be better understood and objects other than those set forth above will become apparent when consideration is given to the following detailed description thereof. This description makes reference to the annexed drawings, wherein:

FIG. 1 shows a top section view of a main housing of a locking device according to one embodiment of the invention in an opened state,

FIG. 2 shows the top section view of the main housing of the locking device of FIG. 1 before attaching the back case to the front case,

FIG. 3 shows the top section view of the main housing of FIG. 2 in an attached and secured state of the back and front case and with interlocked cable ends,

FIG. 4 shows the top section view of the main housing of FIG. 3 with cable ends secured to the housing,

FIG. 5 shows a side view of the main housing in an alternative embodiment,

FIG. 6a a side view of a clamp of an alternative embodiment of the locking device mounted on a bicycle,

FIG. 6b a side view of a clamp and a component case of the alternative embodiment of the locking device mounted on a bicycle,

FIG. 6c a side view of a clamp and a component case of the alternative embodiment of the locking device mounted on a bicycle and in a locked position,

FIG. 7 a front view of the main housing of the locking device according to the alternative embodiment,

FIG. 8a a section view of the component case of the alternative embodiment of the locking device according to lines AA of FIG. 6b, and

FIG. 8b a section view of the clamp of the alternative embodiment of the locking device according to lines BB of FIG. 6b.

### MODES FOR CARRYING OUT THE INVENTION

Functionally or structurally similar elements may be denoted by same reference numerals in different figures or embodiments of the invention.

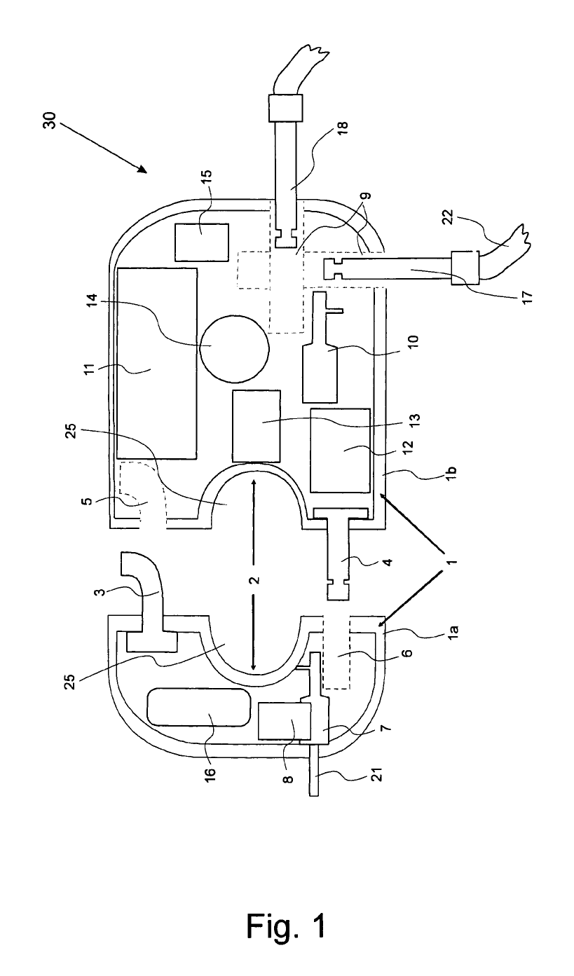

FIG. 1 shows a top section view of a main housing 1 of a first embodiment of a locking device 30 according to the invention in an opened state. For reasons of simplicity only the cable ends 17, 18 of the cable 22 are shown in the figures. Furthermore, no electrical connections between the elements inside the main housing 1 are shown for clarity reasons. However, the skilled person in electrical engineering knows how to wire the elements. In the following, components of the main housing 1 will be described in a rather general way with reference to FIG. 1 and their function will be described in more detail in the sections relating to the following figures.

The main housing 1 comprises a back case 1a and a front case 1b which are detachably attachable to one another by means of first attachment means 3, 5 and second attachment means 4, 6, 7. It is noted that the arrangement of components described throughout the present application as being located inside the back or the front case is to be seen as exemplary, other placements of the components are possible and shall be considered as incorporated herein. The main housing 1 is preferably made of resistant and weather-proof, preferably lightweight, metal alloy or plastic, or a combination thereof and is preferably box-shaped, however it may have another shape for greater compatibility with different bicycle frame models.

As mentioned, the locking device 30 comprises a cable 22, the cable ends 17, 18 of which are removably insertable into cable cavities 9 of the front case 1b. The cable ends interlock and are secured, in an interlocked state of the cable 22, by first retaining means 10 provided inside the front case 1b.

The first attachment means comprise a bolt 3 protruding from the back case 1a and a first cavity 5 arranged in the front case 1b. The first cavity 5 is illustrated by dashed lines. The bolt 3 is curved towards its outer extremity and is insertable and removably lockable inside the first cavity 5.

The second attachment means comprise second retaining means 7 and a second cavity 6 arranged inside the back case 1a and a notched bolt 4 protruding from the front case 1b.

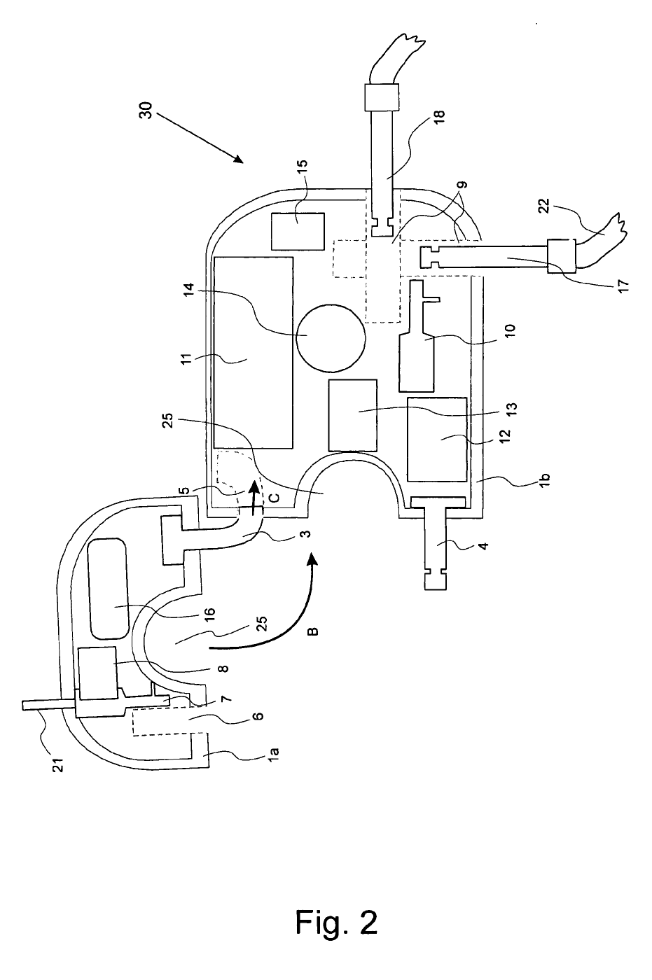

The back case 1a further comprises a compartment 8 containing separately a glue material, particularly epoxy resin, and a hardener. This compartment may be optionally used for further securing the main housing 1 in a locked state of the back and the front case 1a, 1b. This will be explained in further detail with reference to FIG. 2.

The back case also comprises a power supply 16, particularly a Li-ion battery. It is self understood that other types of batteries may be used instead the Li-ion battery. It is furthermore preferred that the battery is rechargeable.

A radio frequency device 11 which is arranged in the front case 1b, comprises as radio frequency chip a GSM module connected to a SIM-card 13. In the context of the present application the SIM-card 13 may also be a microSIM-card. The radio frequency device 11 may also additionally comprise a Bluetooth® module or the Bluetooth® module may be present instead of the GSM module with the SIM-card.

The front case 1b further comprises a piezoelectric device 14, preferably capable of emitting sound of at least 120 dB, and a vibration detector and/or a accelerometer or gyroscope 15, which are adapted to trigger an alarm upon detection of a threshold measurement value.

Also, arranged inside the front case 1b, there is a GPS module 12 for locating the locking device.

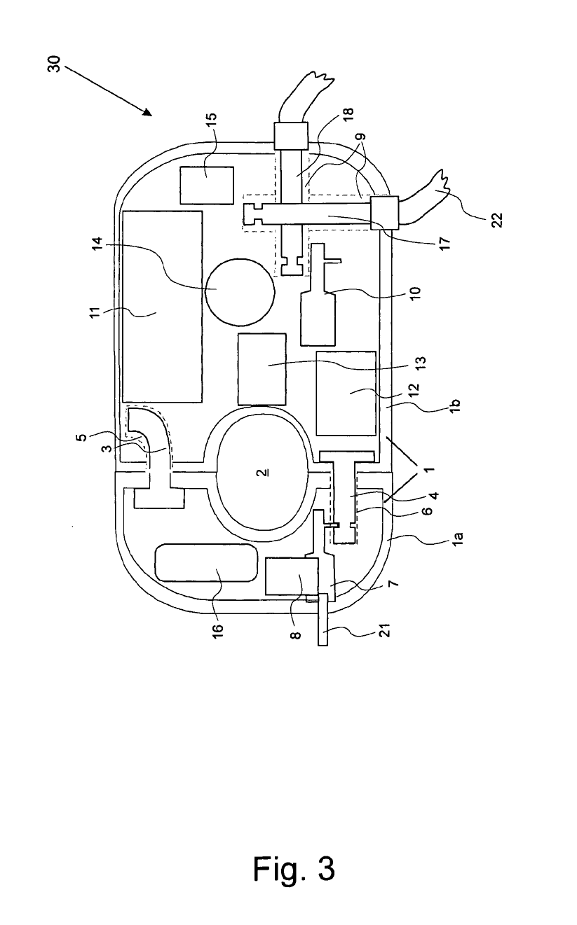

FIG. 2 shows the top section view of the main housing of the locking device of FIG. 1 before attaching the back case 1a to the front case 1b. The back case 1a and the front case 1b are formed in such a way that in an attached state they form a rounded cavity 25 for embracing the component of the bicycle. In FIG. 2 the back and the front case 1a, 1b of the main housing 1 are shown with the bolt 3 just inserted into the first cavity 5. The rounded cavity 25 of the back case 1a and the front case 1b are opened to the exterior and form the space 2 shown in FIG. 3 in the attached state of the back and the front cases 1a, 1b. This space 2 receives a bicycle component. Preferably, said bicycle component is a frame tube of the bicycle. The diameter of the space 2 is somewhat larger than the diameter of the frame tube of the bicycle, e.g. at around 3.5 cm. Using rubber padding and/or memory foam the main housing 1 is affixed to the tube such that it is securely attached thereto in order to prevent shifting or movement. In this context it shall be noted that the term bicycle is meant as a general term herein, e.g. also comprising tricycles and motorcycles. The rounded cavities 25 of the back and the front case 1a, 1b forming the space 2 may have other shapes than the one shown in this embodiment. They may be adjusted to fit all types of transversal sections of frames of commercially available bicycles, including their dimensions, e.g. the main housing 1 may be provided with rounded cavities 25 adapted to embrace all usual frame diameters.

As mentioned, the first and the second attachment means comprise each interacting elements 3, 5 and 4, 6, 7 arranged in or on the back case 1a and in or on the front case 1b, which are used to attach and lock the main housing 1 to a component, e.g. the frame, of the bicycle. The attachment and locking is done in the way explained in the following.

In a first step the front case 1b is positioned close to the component, with the rounded cavity 25 facing the component. Subsequently, the back case 1a is positioned at such an angle with respect to the front case 1b that the bolt 3 protruding from the back case 1a is insertable into the first cavity 5 arranged in the front case 1b. In a third step the bolt 3 is inserted into the first cavity 5 and the back case 1a is rotated, denoted with the arrow B, towards the front case 1b until the bolt 3 is entirely inserted into the first cavity 5, denoted by arrow C, and the notched bolt 4 is inserted into the second cavity 6 of the back case 1a. It is noted that the rotation of the back case 1a is imposed by the curvature of the bolt 3 and of the first cavity 5. In a fourth step the back and the front case 1a, 1b are secured to each other by moving the second retaining means 7, here a pin, via the servo 21, such that the pin of the second retaining means 7 engages with the notched bolt 4.

Particular features of the locking elements will be explained in more detail in the following. The fourth step will be explained in more detail with reference to FIG. 3.

Preferably, the radio frequency device 11 comprises the GSM integrated circuit coupled to the SIM-card 13 for use on mobile networks world-wide. The GSM system provides remote connectivity of the device permitting integration with smartphone applications on the iOS, Android and other operating systems. Via GSM a parameter, in other words the various tampering detection systems, alert the user for example in case a theft is being attempted. The parameter sent by a signal to the user of the bicycle or to a security company may be a locking state of the locking device and/or a location of the locking device and/or a battery power state. The parameter can be delivered by text (SMS) message, email or via push notification to the user's mobile application. The alert includes a timestamp, information regarding which detection system activated the alarm, and the most recent location of the device. Through the same mobile application, or by text reply, various options can be selected including ignoring the alert or changing the alert settings, disabling the lock mechanism, initiating active tracking and activation of an audible alarm. The GSM module also provides location and tracking of the device at moderate accuracy with rapid start, while the GPS module 12 acquires adequate satellite signal or when the GPS is unavailable (e.g. indoors, tunnels, covered parking, etc.). The GPS integrated circuit and antenna are also located inside the front case 1b and provide high-accuracy location and tracking of the device. This is used not only in case of theft but can be additionally used for recreational and training purposes in combination with mobile, desktop or online software. When the locking device 30 is used for bicycle sharing, the GPS module can also provide geofencing in order to alert the owner that the bicycle has been taken beyond the set perimeter.

The main housing 1 also comprises further elements intended as alarms against attempts to remove the back case 1a from the front case 1b and/or the cable 22. These include the piezoelectric device 14 mentioned with reference to FIG. 1. The piezoelectric device 14 preferably issues tones of mid to high frequency in the human audible spectrum with a capacity to emit a sound preferably at a minimum of 120 dB and a maximum of 150 dB. At close range (around 2 metres), this sound is capable of producing a painful stimulus as well as attracting the attention of bystanders and thus is an excellent theft deterrent. The alarm level and trigger thresholds may be set via the mobile application which interacts with the GSM module. To prevent hearing damage in case of inadvertent activation the alarm produces a lower (50 dB) sound initially and increases within 30 sec to its maximum capacity for 10 seconds before reducing to the lower level. Further tampering will again increase the sound to the maximum level.

A further element for tampering detection is the vibration detector or the accelerometer or gyroscope 15 housed within the front case 1b. When a certain level of vibration/motion is detected within a predetermined time interval, this triggers the security alert.

Moreover, the locking device 30 may comprise within the front case 1b, additionally or alternatively to the GSM system, an RF system like a Bluetooth module that permits operation of the locking mechanism remotely but at a relative proximity of a few centimetres up to a few meters. The Bluetooth system permits interaction with all components of the device via the mobile application and the Bluetooth system of the smartphone. The Bluetooth module would only permit the inactivation of the antitheft system and the release of the locking mechanism if activated and locked, or the activation of the antitheft system and locking mechanism if inactive and unlocked. In a typical application the user pairs his mobile phone with the Bluetooth module of the locking device 30. When the user approaches the locking device 30, his phone will automatically detect the proximity of the Bluetooth module of the locking device 30 and will initiate an authentication procedure. Upon successful authentication the Bluetooth module of the locking device 30 will issue an internal signal triggering the automatic unlocking of the cable. Also, the cable may be automatically locked when the user (and his mobile phone) moves out of the reception range of the Bluetooth module of the locking device 30, provided the cable has been inserted into the main housing.

As described in connection with the Bluetooth module the locking device can be remotely locked and/or unlocked. This can not only be done contactless from proximity by means of the Bluetooth module, but also via a network by internet, sms, etc.

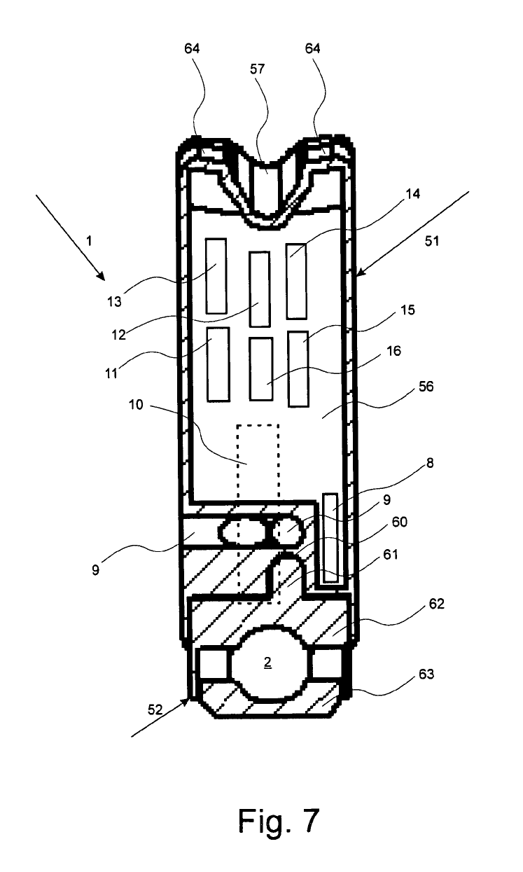

As mentioned, the battery 16 is preferably rechargeable. The recharging of the battery 16 can be carried out by connecting the battery to an external charger. In this case the back case 1a comprises a suitable connector for the external power source. The recharging may alternatively or additionally be carried out by means of photovoltaic cells 19 and/or by inducing an electromagnetic field by means of coils 20 and at least a magnet. These modes are explained later with reference to FIG. 7.

The main housing 1 may also contain at least a LED light, which is not shown in the figures. It may indicate the activation status of alarms, tampering detectors and battery status. The LED or additional LEDs may be activated primarily when cycling at night, triggered by low ambient lighting, for increased visibility and security.

FIG. 3 shows the top section view of the main housing 1 of FIG. 2 with interlocked cable ends 17, 18 and secured back and front case 1a, 1b. It is noted that the interlocking of the cable ends 17, 18, which is described in the following, is an example and other interlocking techniques and elements may be used instead.

In the illustrated example, which is a preferred embodiment of the retaining means 7, the latter is formed by a cylinder and a pin attached thereto. The pin of the second retaining means 7 may form an integral part of the cylinder. The cylinder is accessible from the outside of the back case 1a and can be actuated by a user of the locking device 30 by means of the servo 21. The second attachment means also comprise a notched bolt 4 which protrudes from the front case 1b. The notched bolt 4 is insertable into the second cavity 6 and detachably attachable therein by means of engagement with the pin. In a known way, the servo 21 moves the cylinder, especially rotates it, and by this, depending on the degree of rotation, locks or unlocks the cable bolts of the retaining means or secures or releases the main housing or the clamp and the component case (see alternative embodiment of the locking device). In this example, the engagement is carried out by rotating the pin into the notch of the notched bolt 4. By this, the notched bolt 4 is secured inside the second cavity 6. It is understood that other interacting locking mechanisms than the pin and the notched bolt 4 can be used.

Additionally to the described locking, it may be preferred that an additional securing of the main housing 1 to the bicycle frame is carried out. This additional securing is reached by releasing the glue material and the hardener from the compartment 8 into the interior of the back case 1a after securing the latter to the front case 1b. In the present example this is done substantially at the same time when the servo 21 is turned in order to insert the pin into the notch of the bolt 4 or in case of the alternative embodiment of the locking device described below, when the clamp is inserted into the component case. For this, the compartment 8 is adapted to break when the cylinder is turned, such that the two separated substances, the glue and the hardener, are spilled out into the back case 1a where they mix and harden around the locked pin and notch-bolt 4. By this, the pin and the notched bolt 4 are permanently fixed in their secured position and cannot be removed from the frame anymore, even in case of an attempt to reopen the cylinder mechanism or the locking barrel (see alternative embodiment of the locking device), e.g. by manipulation of the electronic system or mechanism. In an alternative embodiment the compartment 8 can be opened by other means from the outside of the back case 1a at anytime, not necessarily when the cylinder of the retaining means 7 is turned.

The cable ends 17, 18 are adapted, in a locked state of the cable 22, to close an electric circuit. The locking device 30 is adapted to trigger an alarm if the closed circuit is interrupted or alternatively if an open circuit is closed whilst cutting of the cable. The electric circuit is executed by means of an insulated electric wire or wires contained within the cable 22 and protruding through one or both cable ends 17, 18. The wire terminals are isolated from the metal in the bolt heads and the braided wire in the cables thus forms a closed circuit when secured inside the locking device 30. If the cable is cut the circuit is interrupted and the alarm is triggered. The end bolts 17, 18 of the cable 22, interlock, as previously mentioned, within the main housing 1. One end bolt 17 has a cylindrical bore near the end through which the other bolt 18 extends when inserted in the main housing 1.

In an alternative embodiment the cable ends 17, 18 are electrically isolated when they interlock. In any of the two cases a resistance measurement is carried out in order to determine the state of the cable 22. This is known to the skilled person and will not be described here in more detail.

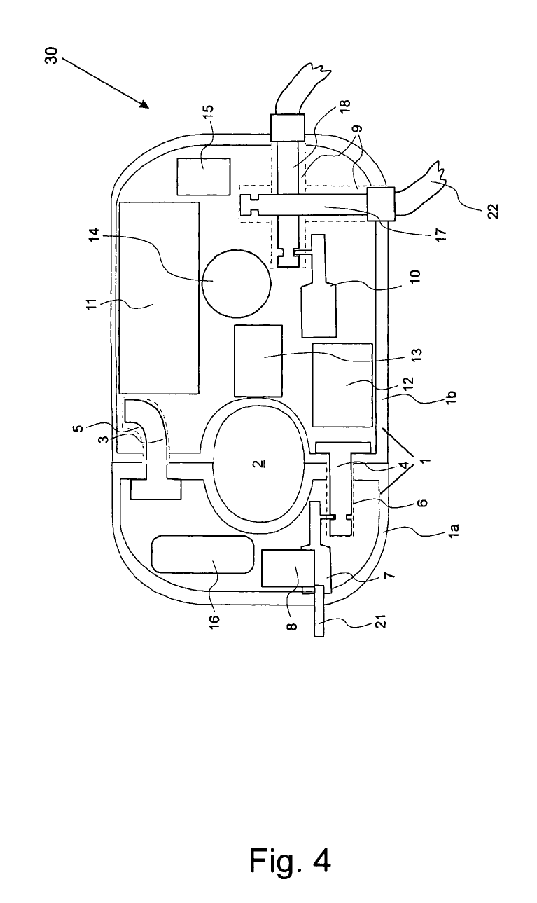

FIG. 4 shows the top section view of the main housing of FIG. 3 with a cable end secured to the housing 1. The bolt 18, which is inserted into the cable end 17 as described above, has a notch near the end which interacts with the first retaining means 10 inside the front case 1b. The first retaining means 10 comprise a pin in this example and is rotated until the pin engages the notch of the bolt 18. This prevents the bolt 18 from being removed from the main housing 1, which in turn prevents the bolt 17 from being withdrawn as well. Even though the embodiment described above, wherein one cable end 17 is adapted to interlock with the first retaining means 10, is preferred because it is cheaper, additional retaining means for the other cable end 17, which may be identical to the first retaining means 10, may also be provided in order to secure the cable end 17 as well. The motion of the pin into and out of the securing position is carried out by an actuator, preferably an electric actuator (not shown) located inside the front case 1b and powered by the battery 16.

The cable 22, which is preferably made of wire or wires or an interlinking chain or alternative elements made of steel or an alternative high strength material, can be produced in various calibers and lengths permitting the user to decide the level of security required. Being completely detachable, the cable 22 will not obstruct cycling in any way.

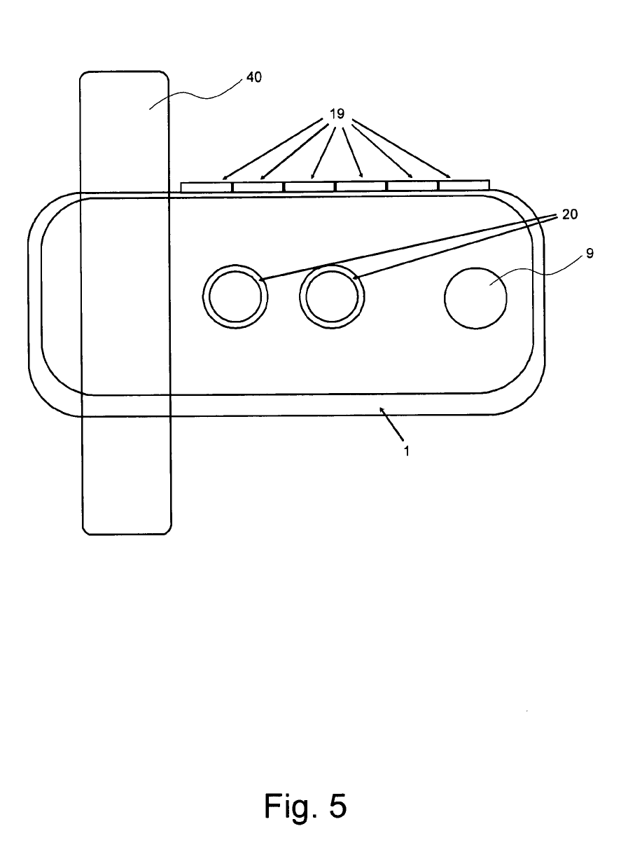

FIG. 5 shows a side view of the main housing 1 in an alternative embodiment. The alternative embodiment comprises further elements in addition to the elements described with reference to the previous figures.

In this embodiment the locking device 30 is attached to a bicycle frame 40 and comprises photovoltaic cells 19 arranged on the top outer surface of the main housing 1. Furthermore the cable cavity 9 for receiving the cable end 17 is shown in FIG. 5. It is preferred that the Li-ion battery 16 may also be recharged by means of the photovoltaic cells 19. Additionally or alternatively it can also be recharged by the external power source, as mentioned. By means of the array of miniature photovoltaic cells 19 arranged on the top of the front case 1b, continuous trickle electric current is supplied to charge the battery and to operate the circuitry in standby mode when sufficient ambient light is present. When the ambient light is insufficient, or additional power is needed (i.e. when actively transmitting signals or powering the locking mechanism), the device utilizes charge from the battery.

This embodiment further has a number of copper wire loop coils 20 scattered throughout the periphery of the front case 1b. At least a magnet is attachable to at least a periodically moving part of the bicycle (e.g. pedal crank arm, wheel spokes, etc.). The means of attaching the magnets is by embedding them in an array along a modified bicycle spoke reflector and attaching this to the wheel at the correct radial distance. This is not shown in FIG. 5. When the main housing 1 of the locking device 30 is secured either on one of the seat or chain stays, or fork, the magnet, preferably a plurality of magnets, preferably neodymium magnets, which in this case are attached to the wheel spoke by means of the modified spoke reflector or otherwise, produce an electric current by means of electromagnetic induction as they pass the main housing 1. When the main housing is secured either to the down or seat tube, the magnets can be attached to the inside of the pedal crank arm such that they also pass the main housing when the bicycle is in motion. The energy produced when the bicycle is in motion is also stored in the battery, providing an alternative charging method when ambient light is low or when solar charging is not used. In addition, if the device is attached as suggested to the chain stay, an additional magnet may be placed on the heel of the bicycle, or other, shoe. This system can also be used to measure cadence and velocity to work in combination with the positioning system in order to determine exercise parameters.

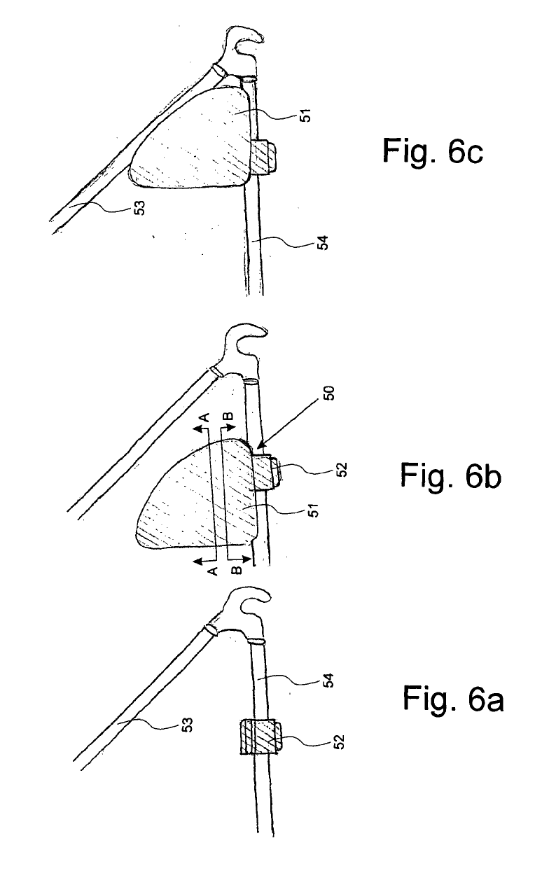

In the following an alternative embodiment of the locking device 50 according to the invention will be described. FIGS. 6a to 6c illustrate as an overview a three step procedure for attaching the locking device 50 to a bicycle frame. The clamp 52 comprises a set of threaded bolts (not shown) protruding through holes in the first clamping element 62 and into a set of equally positioned threaded holes in the second clamping element 63. This way of attaching the two clamping elements 62, 63 to one another is preferred because the threads are not accessible after the component case 51 has been attached and secured to the clamp 52. Thus, it is not possible to remove the entire main housing 1.

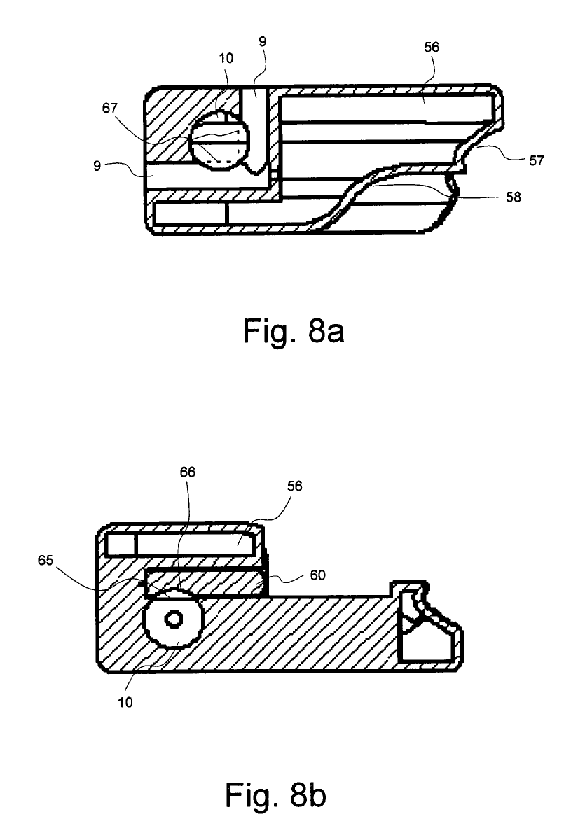

A more detailed description of the elements of the alternative embodiment of the locking device 50 will be given in FIGS. 7, 8a and 8b.

FIG. 6a shows as a first step a side view of a clamp 52 of the alternative embodiment of the locking device. The clamp is mounted on a bicycle, of which only a seat stay 53 and a chain stay 54 are shown for simplicity reasons.

FIG. 6b shows as a second step a side view of the clamp 52 and a component case 51 of the alternative embodiment of the locking device 50. In this figure the component case 51 has been attached to the clamp 52. Two view lines AA and BB are also shown in this figure. They relate to section views shown in FIGS. 8a and 8b respectively.

FIG. 6c shows as a third step a side view of the clamp 52 and the component case 51 of the alternative embodiment of the locking device 50 mounted on the bicycle and in a locked position. In this figure the component case 51 has been slid backwards onto the clamp 52 until it abuts against the seat stay 53.

FIG. 7 shows a front view of the main housing 1 of the locking device 50 according to the alternative embodiment. FIG. 8a shows a section view of the component case of the alternative embodiment of the locking device according to lines AA of FIG. 6b, and FIG. 8b shows a section view of the clamp of the alternative embodiment of the locking device according to lines BB of FIG. 6b.

The component case 51 is shaped to include a flat bottom surface with a channel 60 to fit on top of the clamp 52. The clamp 52 comprises a first clamping element 62 and a second clamping element 63. As mentioned the component case 51 is detachably attachable to the first clamp element 62 by main attachment means. The main attachment means comprise a ridge 61 on an outer surface of the first clamp element 62 and an elongated cavity 60 in a first wall of the component case 51. The elongated cavity 60 and the ridge 61 cooperate for attaching the component case 51 to the first clamping element 62 in a slideable way.

The front side of the component is curved for improving aerodynamics.

The component case 51 comprises a curved, elongated notch 57 with lateral wings 64. The curvature of the notch can be seen best in FIGS. 6a to 6c. The notch 57 is adapted to receive at least a part of a frame component of the bicycle between the wings 64. In this example the bicycle component is the seat stay 53 of the bicycle. The seat stay 53 partially fills the notch 57 and is partially embraced by the wings 64, as can be seen in FIG. 6c. The frame component, here the seat stay 53, is adjacent to the component of the bicycle, here the chain stay 54, which serves as support for the locking device 50. The elongated notch 57 has a curvature and is adapted to accommodate an arbitrary dropout angle between the seat stay 53 and the chain stay 54. In other words the curvature permits a tangential contact with the seat stay 53. The wings 64 prevent the component case 51 from being rotated about the axis of the clamp 52 on the chain stay 54. The component case 51 has a recess 56 in its interior to fit the electronic components described in connection with the first embodiment 30 of the locking device. The only difference to the first embodiment 30 is that the electronic components, like e.g. Bluetooth module, SIM card are all located inside the one recess 56. Thus, all elements described in connection with the first embodiment as being located inside the back case or the front case are assumed to be located inside the recess 56 in the alternative embodiment. These elements particularly comprise the radio frequency device 11, the GPS module 12, the SIM-card 13, the compartment 8, the power supply 16, the piezoelectric device 14 and the vibration detector 15.

Like in the first embodiment, the component case 51 also comprises cable cavities 9 for inserting the cable ends 17, 18 (see FIG. 1). Retaining means 10 are also used for preventing the cable ends 17, 18 to be pulled out of the respective cavity 9. In this embodiment the retaining means are preferably formed by a locking barrel 10 shown with dashed lines in FIG. 7. The locking barrel 10 has two purposes in this embodiment, which will be explained in the following.

The cylindrical locking barrel 10 is a part of the main attachment means and is thus used for locking the component case 51 to the clamp 52 and unlocking it from the clamp 52. For this purpose it extends towards the outer surface of the first clamp element 62 and has a first lateral notch 65 (see FIG. 8b) at its extremity which faces the outer surface of the first clamp element 62. The ridge 61 of the first clamp element 62 has a second lateral notch 66. The locking barrel 10 is rotatable between a locked and an unlocked position. In the locked position the locking barrel 10 occupies a space in the second lateral notch 66 of the ridge 61 for preventing a sliding movement of the component case 51. In the unlocked position the first lateral notch 65 of the locking barrel 10 faces the second lateral notch 66 of the ridge 61 for allowing a sliding movement of the component case 51. In other words, by rotating the locking barrel around its longitudinal axis its curvature fits into the second notch 66, the wall of which has a mating curvature. In this locking position it is obvious that the component case is blocked and cannot be slid out from the ridge 61. If the locking barrel 10 is turned with its first notch 65 facing the second notch 66 a space between the wall of the second notch 66 and the first notch 65 is created, such that the component case 51 can be slid out from the ridge 61.

The component case 51 contains a cut out in the wall facing the outer surface of the first clamping element 62 that permits a sideways insertion or an insertion from above of the first clamping element 62.

In one embodiment there is a cavity in the wall of the component case 51 that conforms to an outline of the first clamping element 62. Included in this cavity is a railing on both sides that juxtaposes a negative cavity on the first clamping element 62 which permits sliding of the component case 51 over the first clamping element 62 into a secured position. Additionally the first clamping element 62 has the ridge 61, as mentioned above, at its centerline that guides the component case 51 along the first clamping element 62. The ridge 61 also contains a nearly semicircular notch 66 that receives the bottom part of the locking barrel 10. The locking barrel 10 is shaped at its base so that a nearly semicircular cutout (notch 65) is present, as mentioned above. Hence, when the cutout is facing the cavity of the notch 66 it permits the free sliding of the component case 51 over the first clamping element 62. Rotation of 180°, or any fraction for that matter, results in the locking barrel 10 occupying the space in the notch 66 on the ridge 61 of the first clamping element 62, thus preventing the free sliding of the component case 51 along the first clamping element 62 and in such manner secures the component case 51 to the first clamping element 62 and therefore to the bicycle frame.

As mentioned, the locking barrel 10 has the additional purpose of preventing the removal of the cable ends 17, 18 when they are in a locked or interlocked position. It comprises two additional lateral notches 67, each of which is facing one of the cable ends 17, 18 in the unlocked position (see FIG. 8b). Both additional lateral notches 67 face away from the respective cable end 17, 18 in the locked position. The principle is similar to the principle of securing the component case 51 to the clamp 52 described above. An automated actuator (not shown) is attached to the locking barrel 10. The locking barrel fits inside the component case 51 in a cylindrical hole. This barrel hole is partially intersected on the side by the holes 9 for the locking cable bolts which are terminally intersecting and perpendicular. The cable bolts contain an axial curved notch along a stretch of the bolt that has the same radius of curvature as the locking barrel 10. As previously mentioned the locking barrel 10 has a cutout at its base; additionally it contains, at or near its top, another set of secant cutouts 67 arranged at right angles thus producing a fan shaped cross section in the barrel 10. In the unlocked state, the cutouts 67 are aligned to the bolt holes 9 leaving them unobstructed and allowing the insertion or removal of said bolts. In the locked state when the bolts are inserted the barrel 10 spins and the curved sections of the barrel 10 occupy as before the space left by the bolt notches at the intersection of the barrel hole and bolt hole hence preventing the bolts from being retracted and removed.

In one embodiment the component case 51 comprises a retractable blocking bolt (not shown) protruding between spokes of the bicycle in a locked position in order to prevent the respective wheel from turning. The retractable bolt may be controlled by an actuator such that it can be moved from the locked position into an unlocked position and vice-versa without manual intervention.

In another embodiment the component case 51 comprises a resonance chamber for amplification of an alarm sound. Preferably the resonance chamber has a shape of a French horn or a nautilus. The resonance chamber amplifies the sound of the alarm, e.g. the piezoelectric device 14, thus avoiding damage of sensitive electronics by the alarm vibration and reducing battery consumption.

In yet another embodiment the component case 51 comprises a window (not shown) in one of its outer walls. The window fits an antenna for wireless communication. The antenna is electrically connected to electrical components inside the component case 51, e.g. the Bluetooth module or the GSM module, via connection cables fitted in a non-straight channel. The channel is preferably formed labyrinth-like or strongly curved, such that any tampering from outside is considerably exacerbated. Also in view of tampering the window is made of hard material like a thick, rigid plastic.

Similarly to the first embodiment of the locking device the servo 21 may also be used for the alternative embodiment of the locking device in the ways described above.

In one embodiment of the locking device the component case 51 comprises an indentation 58 in a wall facing a disk break of the bicycle in order to avoid contact of the disk break with said wall.

As mentioned in connection with the first embodiment, the battery 16 is preferably rechargeable. The recharging of the battery 16 can be carried out by connecting the battery to an external charger. In this case the back case 1a comprises a suitable connector for the external power source hidden and protected from tampering by the clamp 52 when assembled.

While there are shown and described presently preferred embodiments of the invention, it is to be distinctly understood that the invention is not limited thereto but may otherwise variously be embodied and practiced within the scope of the following claims. Therefore, terms like “preferred” or “in particular” or “particularly” or “advantageously”, etc. signify optional and exemplary embodiments only.

1. Locking device (30; 50) for a bicycle, comprising:
a main housing (1) which is attachable to a component of the bicycle;
a cable (22), wherein both cable ends (17, 18) are lockable inside the main housing (1);
a GPS module (12) for locating the locking device arranged inside the main housing al;
a radio frequency device (11) at least for transmitting at least a signal encoding at least a parameter of the locking device to a remote receiving means, comprising at least a radio frequency chip and an antenna,
characterized in that
the main housing (1) comprises two parts:
either a component case (51) and a clamp (52), wherein the clamp (52) comprises a first and a second clamp element (62, 63) forming in an attached state a space (2) for embracing the component (54) of the bicycle, wherein the component case (51) is detachably attachable to the first clamp element (62) by main attachment means (10, 60, 61)
or a back case (1a) and a front case (1b), which are detachably attachable to one another by first and second attachment means (3, 5; 4, 6, 7), the back case (1a) and the front case (1b) being formed in such a way that in an attached state they form a space (2) for embracing the component of the bicycle and in that the first and the second attachment means comprise each interacting elements (3, 5; 4, 6, 7) arranged in the back case (1a) and in the front case (1b).

2. Locking device according to claim 1, wherein the cable ends (17, 18) are removably insertable into the main housing (1) and interlock, in a locked state of the cable (22), inside the main housing (1), particularly wherein first retaining means (10) are provided inside the main housing (1) and at least one cable end (17) is adapted to interlock with the first retaining means (10).

3. Locking device according to claim 1, wherein the cable ends (17, 18) are adapted, in a locked state of the cable (22), to close an electric circuit and wherein the locking device (30) is adapted to trigger an alarm if the closed circuit is interrupted.

4. Locking device according to, claim 1 wherein the first attachment means comprise a bolt (3) protruding from the back case (1a) and a first cavity (5) arranged in the front case (1b), wherein the bolt (3) is curved towards its outer extremity and is insertable and removably lockable inside the first cavity (5).

5. Locking device according to, claim 1 wherein the second attachment means comprise second retaining means (7) arranged inside the back case (1a) and movable into a second cavity (6) of the back case (1a), and a notched bolt (4) protruding from the front case (1b), which is insertable into the second cavity (6) and detachably attachable therein by means of engagement with the second retaining means (7).

6. Locking device according to, claim 1, wherein a compartment (8) containing separately a glue material, particularly epoxy resin, and a hardener, is arranged inside the main housing (1), the glue material and the hardener being releasable therein for permanently fixing elements of the first and/or the second attachment means and/or the main attachment means (10, 60, 61).

7. Locking device according to, claim 1, further comprising a power supply (16), particularly a Li-ion battery, arranged inside the main housing (1) and/or photovoltaic cells (19) arranged on the outer surface of the main housing (1), particularly wherein the Li-ion battery is rechargeable by an external power source and/or the photovoltaic cells (19).

8. Locking device according to, claim 1, wherein the radio frequency device (11) comprises as radio frequency chip a GSM module connected to a SIM-card (13) and/or a Bluetooth module, arranged inside the main housing (1).

9. Locking device according to claim 7, wherein the SIM card (13) is arranged in a slot which is only accessible when the back and the front case (1a, 1b) or the component case (51) and the clamp (52) are not attached to each other.

10. Locking device according to, claim 1, further comprising a piezoelectric device (14) capable of emitting sound of at least 120 dB.

11. Locking device according to, claim 1, further comprising a vibration detector (15) and/or an accelerometer or gyroscope, arranged inside the main housing (1) and adapted to trigger an alarm upon detection of a threshold measurement value.

12. Locking device according to, claim 1, wherein the locking device further comprises at least one magnet which is attachable to at least a moving part of the bicycle, particularly wheel spokes or the inside of pedal crank arms, and which is able to induce an electromagnetic field in a plurality of copper wire coils (20) arranged in the main housing (1) as the at least one magnet passes the locking device.

13. Locking device according to, claim 1, wherein the parameter of the locking device is a locking state of the locking device and/or a location of the locking device and/or a battery power state.

14. Locking device according to, claim 1, wherein the second attachment means (4, 6, 7) and/or the first attachment means (3, 5) and/or the main attachment means (10, 60, 61) are detachably lockable by means of a servo (21).

15. Locking device according to, claim 1, wherein the main attachment means comprise a ridge (61) on an outer surface of the first clamp element (62) and an elongated cavity (60) in a first wall of the component case (51), wherein the elongated cavity (60) and the ridge (61) cooperate for attaching the component case (51) to the first clamping element (62) in a slideable way.

16. Locking device according to claim 15, wherein the main attachment means further comprise a cylindrical locking barrel (10) extending towards the outer surface of the first clamp element (62), wherein the locking barrel (10) has a first lateral notch (65) at its extremity which faces the outer surface of the first clamp element (62) and the ridge (61) has a second lateral notch (66), wherein the locking barrel (10) is rotatable between a locked and an unlocked position, wherein in the locked position the locking barrel (10) occupies a space in the second lateral notch (66) of the ridge (61) for preventing a sliding movement of the component case (51) and in the unlocked position the first lateral notch (65) of the locking barrel (10) faces the second lateral notch (66) of the ridge (61) of the component case (51) for allowing a sliding movement of the component case (51).

17. Locking device according to claim 2, wherein the first retaining means are formed by a locking barrel.

18. Locking device according to claim 17, wherein the locking barrel (10) has two additional lateral notches (67), each of which is facing one of the cable ends (17, 18) in the unlocked position and both are facing away from the respective cable end (17, 18) in the locked position.

19. Locking device according to, claim 1, wherein the component case (51) comprises a curved, elongated notch (57) with lateral wings (64), wherein the elongated notch (57) is adapted to receive at least a part of a frame component of the bicycle between the wings (64), particularly a seat stay (53) of the bicycle, wherein the frame component is adjacent to the component of the bicycle, particularly a chain stay (54) of the bicycle, which serves as support for the locking device (50).

20. Locking device according to claim 19, wherein the elongated notch (57) has a curvature and is adapted to accommodate an arbitrary dropout angle between the frame component (53) and the component (54) of the bicycle.

21. Locking device according to claim 1, wherein the component case (51) comprises a retractable blocking bolt protruding between spokes of the bicycle in a locked position in order to prevent the respective wheel from turning.

22. Locking device according to one of the preceding claim 1, wherein the component case (51) comprises a resonance chamber for amplification of an alarm sound, particularly wherein the resonance chamber has a shape of a French horn or a nautilus.

23. Locking device according to claim 1, wherein the component case (51) comprises a window in one of its outer walls, wherein the window fits an antenna for wireless communication, wherein the antenna is electrically connected to electrical components inside the component case (51) via connection cables fitted in a non-straight channel.

24. Locking device according to claim 1, wherein the component case (51) comprises an indentation (58) in a wall facing a disk break of the bicycle in order to avoid contact of the disk break with said wall.

25. Locking device according to claim 1, wherein the locking device is remotely lockable and/or unlockable, particularly in a contactless way.

26. Method for securing a locking device according to claim 1 to a bicycle, comprising the step of embracing a component of the bicycle, by the back and front the case (1a, 1b) or by the first and the second clamp elements (62, 63).

27. Method according to claim 26, wherein:
the first clamp element (62) and the second clamp element (63) are locked to one another, embracing the component (54) of the bicycle, by at least one securing bolt,
the component case (51) is slid with an elongated cavity (60) onto a ridge (61) of the first clamp element (62) until a curved, elongated notch (57) of the component case (51) has received a frame component (53) of the bicycle adjacent to the component (54) of the bicycle which serves as support for the locking device (50), and
a locking barrel (10) arranged inside the component case (51) is rotated into a locked position in which the locking barrel engages with the ridge (61) for preventing a sliding movement of the component case (51).

28. Method according to claim 26, wherein:—the front case (1b) is positioned close to the component with a rounded cavity (25) facing the component,
the back case (1a) is positioned at such an angle with respect to the front case (1b) that a bolt (3) protruding from the back case (1a) is insertable into a first cavity (5) arranged in the front case (1b),
the bolt (3) is inserted into the cavity (5) and the back case (1a) is rotated towards the front case (1b) until the bolt (3) is entirely inserted into the first cavity (5) and a notched bolt (4) protruding from the front case (1b) is inserted into a second cavity (6) in the back case (1a),
the back and the front case (1a, 1b) are secured to each other by moving a second retaining means (7) of the second attachment means, arranged inside the back case (1a), via a servo (21), such that the second retaining means (7) engages with the notched bolt (4), and particularly wherein
the first and/or the second attachment means (3, 5; 4, 6, 7) are permanently fixed in the locked state of the back and front case (1a, 1b) by releasing the contents of a compartment (8) arranged inside the main housing (1) and containing separately a glue material, particularly epoxy resin, and a hardener, into the main housing (1).
